(19) United States
(12) Patent Application Publication
(10) Pub. No.: US 2006/0236592 A1
(43) Pub. Date: Oct. 26, 2006

(54) Insect trap

(76) Inventor: Glade Everett Hall JR., Seneca Falls, NY (US)

Correspondence Address: LAW OFFICE OF MICHAEL A. BLAKE, 112 BROAD STREET, MILFORD, CT, 06460, US

(21) Appl. No.: 11/113,626

(22) Filed: Apr. 25, 2005

(51) Int. Cl. A01M 1/10

(52) U.S. Cl. 43/122

(57) ABSTRACT

An insect trap comprising: a cap; a container removeably coupled to the cap; an aperture located on the cap forming a passage way from outside of the container to the interior of the container; the aperture comprising an exterior-side and a container-side; and a supple sleeve located adjacent to the container-side of the aperture. A supple sleeve configured to be attached to at least one aperture wall forming an aperture in an insect trap.

### TECHNICAL FIELD

The present invention relates to an insect trap, and more particularly, to a trap for flying insects.

### BACKGROUND

The use of traps to eliminate insects is well known. The traps may be used to protect fruits, vegetables and other foodstuffs from being eaten or contaminated by the insects. Likewise, the traps may be used to eliminate insects from within a building. Perhaps the most common use of insect traps, however, are those used outside of dwellings to eliminate or minimize the number of flying insects which may interfere with enjoyment of the area.

To accomplish this purpose, there are numerous different types of traps. One popular trap is formed of an elongate strip of paper or some other material. A scent is applied and the paper is covered with a sticky, glue-like substance. When the flying insect lands on the paper, the glue-like substance prevents the insect from escaping and the insect eventually dies.

While such a trap is economical, there are disadvantages. First, the sight of numerous dead insects along a piece of paper is generally unappealing. Second, people occasionally bump into the piece of paper and contact both the insects and the glue-like substance. Additionally, this type of trap is limited to only small flying insects, such as flies and mosquitoes.

Another popular flying insect trap is a device which has a bright light to attract flying insects. An electrified metal grate is disposed about the light. As the insect flies toward the light, it contacts the electrified metal grate. The insect is then electrocuted and causes no additional disturbance to those using the outdoors adjacent the trap.

Such traps, however, have several disadvantages. First, the devices are relatively expensive. Second, the devices require electricity to power the light and to electrify the metal grate. Third, the sound of the device can become annoying to many. As the electricity from the metal grate electrocutes the flying insect, a distinctive zapping sound is heard. If numerous flying insects are caught in the trap, the repeated sound can become tiresome, and can interfere with conversations of those near the trap.

Another type of solution is a trap which is of considerably less complexity, and in many instances, of greater usefulness. The trap has a container, such as a jar, into which meat, spoiled fruit or some other bait is placed. A cover/trap is then placed on the jar. The cover has several apertures disposed therein. The apertures are disposed to effect two purposes. First, the apertures allow the scent of the bait to diffuse into the surrounding area. As the scent spreads, insects are attracted to the cover. The scent leads the insects through the apertures formed in the cover and to the bait within the jar. Once in the jar the insects are effectively trapped. This is accomplished by coloring the cover black, limiting light flow through the apertures and using a transparent or translucent jar to hold the bait. Because most insects will seek light, many of the insects inside the jar will never find their way out. Rather, they will repeatedly fly into the wall of the jar, or get stuck in the bait, and eventually die. When the jar is full of insects, one may make sure all the insects are dead, remove the cover, dump the insects into the garbage. Some jars must be thrown out, others may be washed, and the cover reattached for subsequent use.

However, the above described trap allows too many insects to escape from the trap. Thus, there is a need for a flying insect trap that better prevents insects from escaping the trap.

### SUMMARY

The disclosed apparatus relates to an insect trap comprising: a cap; a container removeably coupled to the cap; an aperture located on the cap forming a passage way from outside of the container to the interior of the container; the aperture comprising an exterior-side and a container-side; and a supple sleeve located adjacent to the container-side of the aperture.

The disclosed apparatus also relates to a supple sleeve configured to be attached to at least one aperture wall forming an aperture in an insect trap.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a perspective view of the disclosed insect trap;

FIG. 2 is a cross-sectional view of the disclosed insect trap from FIG. 1;

FIG. 3 is a perspective view of a disclosed supple sleeve; and

FIG. 4 is a bottom view of a disclosed supple sleeve.

### DETAILED DESCRIPTION

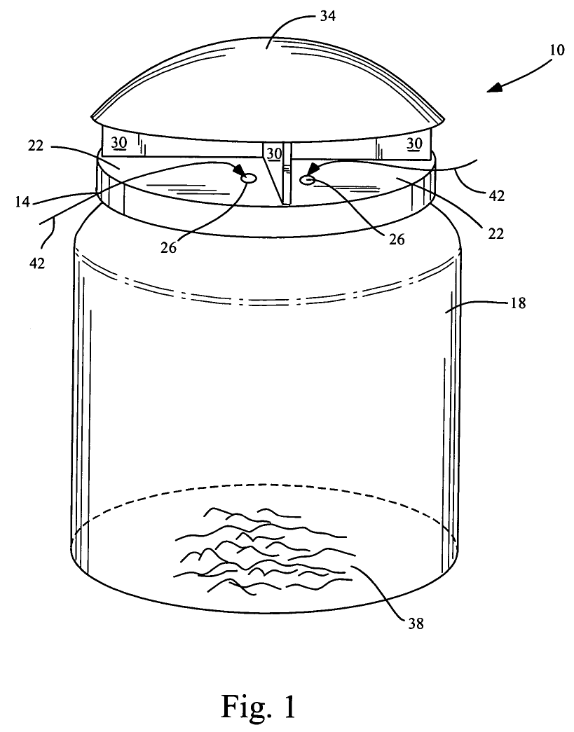

Referring to FIG. 1, there is shown a perspective view of an insect trap 10. The trap 10 comprises a cap 14 removeably coupled to a container 18. The container 18 may be made of a transparent or translucent material. The cap 14 has a generally planar surface 22 with at least one aperture 26 located thereon. If there is more than one aperture 26, then each of the apertures 26 may be separated from one another by a plurality of one or more walls 30. The walls 30 and apertures 26 may be covered by a dome shaped top 34.

In use, fruit, meat, juice, sugar water or some other bait 38 may be placed in the jar. A scent of the bait 38 may gradually diffuse out of the apertures 26 and attract insects toward the trap 10. As they follow the smell, the insects will generally follow the path designated by arrows 42.

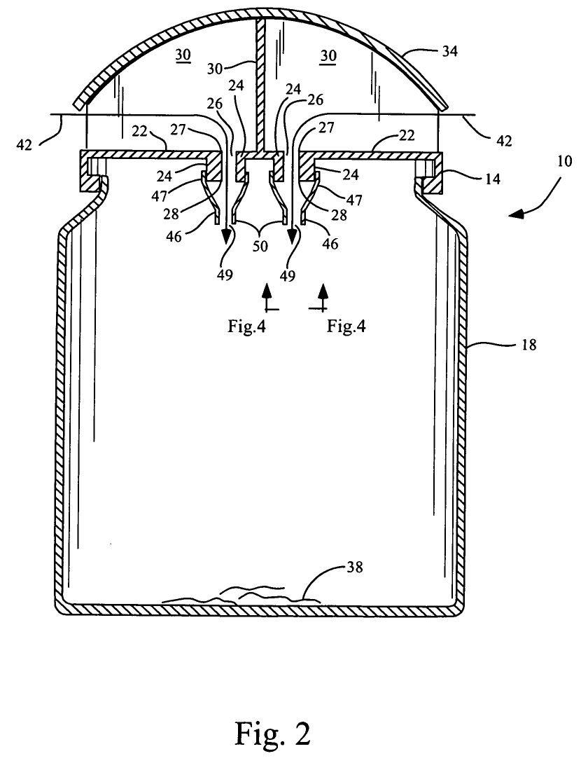

Referring now to FIG. 2, there is shown a side cross-sectional view of the flying insect trap 10 shown in FIG. 1. The trap 10 includes the generally planar surface 22, the apertures 26, walls 30, container 18, domed shape top 34 and cap 14. As can be seen in this view, the apertures 26 are formed by an aperture wall 24. The aperture wall 24 may be cylindrical in shape, or may be any other shape so long as it allows for insects to move from outside the trap 10 to inside the container 18. The aperture 26 forms a passage way from outside of the container 18 to the interior of the container 18. The aperture 26 has an exterior-side 27 and a container-side 28.

Also shown in this view and not visible in the FIG. 1 view, are sleeves 46 coupled to the aperture walls 24. The sleeves 46 are configured to be supple and pliable such that it allows an insect to crawl down the sleeve from the outside of the container 18 into the container 18, generally following the path designated by the arrow 42. However, since the sleeves are supple and pliable, it will be very difficult, if not impossible, for the insects to exit the container 18 via the sleeves 46. The sleeves may be made from any supple material, including but not limited to latex, rubber, nylon, plastic, vinyl, paper, cloth and foil. The sleeve 46 may be tapered at its downward end 50. The sleeve shape tapers from a generally round opening 47 near the aperture walls 24 to a generally smaller elliptical opening 49 near its downward end 50. The generally smaller elliptical opening 49 allows scent from the bait 38 to enter and exit through the generally round opening, thereby attracting insects to the trap. Additionally, the generally smaller elliptical opening 49 may allow light to enter the sleeve 46 and exit through the generally round opening 47, which also may attract insects. The round to elliptical taper of the sleeve 46 may be obtained by lightly creasing and flattening a tapered piece of light, flexible and subtle material. When an insect attempts to crawl down the sleeve 46, the weight of the insect tends to close the generally smaller elliptical opening 49, and interferes with the insects attempt to exit the sleeve through the generally round opening 47.

Other methods may be used in cooperation with the sleeves 46 to keep the insects from escaping the container 18. Thus, the cap 14, surface 22, the underside of the dome shaped top 34, and the aperture walls 24 may be painted, or otherhow colored, black or some other very dark color. Because little or no light comes through the apertures 26, the insect does not try to escape the container via the sleeves. Rather, the insect will repeatedly fly or crawl into the sides of the container 18 until it collapses and dies. This is primarily because most insects search for light.

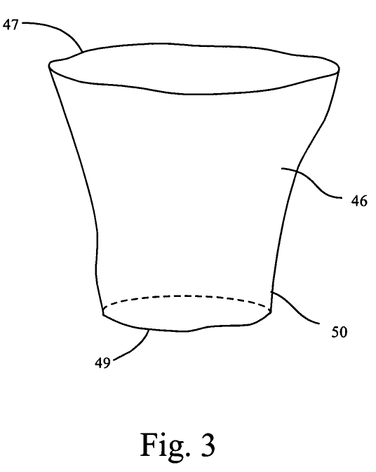

FIG. 3 shows a perspective view of the sleeve 46. In this view, the sleeve 46 is shown to have a taper near its downward end 50. However, in other embodiments, the sleeve may not have a taper, or may have a flare at its end 50.

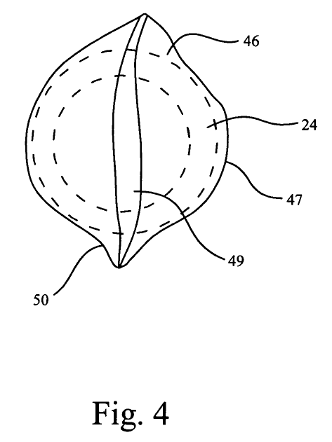

FIG. 4 shows a bottom view of one sleeve 46 attached to an aperture wall 24. As can be seen in this view, the sleeve has a generally round opening 47 about the aperture wall 24. Additionally, the sleeve has a generally smaller elliptical opening 49 near its downward end 50.

The disclosed sleeves 46 may be removable from the aperture walls 24, or may be permanently attached. The sleeves 46 may be an aftermarket addition to an insect trap. The sleeves may be used in other traps with different configuration than the one shown in FIGS. 1 and 2. If the other traps use some sort of passage way into a container, and it is important to keep insects from leaving the container via the passageway, the sleeves 46 may be coupled to the container side of the passageway to prevent the insect from escaping the container.

The disclosed trap 10 is easy to use, and inexpensive to manufacture, and better able to trap insects than traps without sleeves 46. Additionally, the sleeves 46 may be an inexpensive and easy to use aftermarket addition to insect traps.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims

What is claimed is:

1. An insect trap comprising:
a cap;
a container removeably coupled to the cap;
an aperture located on the cap forming a passage way from outside of the container to the interior of the container; the aperture comprising an exterior-side and a container-side; and a supple sleeve located adjacent to the container-side of the aperture, the supple sleeve comprising:
a generally round opening located adjacent to the container-side of the aperture,
a generally smaller elliptical opening located on an opposite end of the supple sleeve from the generally round opening; and
wherein the generally smaller elliptical opening is configured to tend to close when an insect attempts to crawl on the supple sleeve.

2. The insect trap of claim 1, wherein at least one aperture wall forms the aperture, and wherein the supple sleeve is coupled to said at least one aperture wall.

3. The insect trap of claim 1, wherein the supple sleeve is made from a material selected from the group consisting of latex, rubber, nylon, plastic, vinyl, paper, cloth and foil.

4. The insect trap of claim 1, wherein the container is transparent.

5. The insect trap of claim 1, wherein the supple sleeve is of a light color.

6. The insect trap of claim 1, wherein the cap is of a dark color.

7. The insect trap of claim 1, further comprising:
a domed shape top coupled to the cap.

8. The insect trap of claim 7, wherein the underside of the domed shaped top is of a dark color.

9. (canceled)

10. A supple sleeve configured to be attached to at least one aperture wall forming an aperture in an insect trap, the supple sleeve comprising:
a generally round opening located adjacent to the aperture wall;
a generally smaller elliptical opening located on an opposite end of the supple sleeve from the generally round opening; and
wherein the generally smaller elliptical opening is configured to tend to close when an insect attempts to crawl on the supple sleeve.

11. The supple sleeve of claim 10, wherein the supple sleeve is made from a material selected from the group consisting of latex, rubber, nylon, plastic, vinyl, paper, cloth and foil.

12. The supple sleeve of claim 10, wherein the sleeve tapers from a generally round opening to a generally smaller elliptical opening.
